(19) United States
(12) Patent Application Publication
(10) Pub. No.: US 2010/0035119 A1
(43) Pub. Date: Feb. 11, 2010

(54) STABLE TEMPERATURE PLASMA TREATED FORMATION, AND METHOD FOR THE PRODUCTION THEREOF

(75) Inventors: Klaus-Dietmar Wagner, Heddesheim (DE); Gunter Scharfenberger, Frankenthal (DE); Birgit Severich, Mannheim (DE); Kristina Margarit-Puri, Gorxheimertal (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 12/519,595

(22) PCT Filed: Nov. 21, 2007
(86) PCT No.: PCT/EP2007/010064

§ 371 Date: Jun. 17, 2009

(30) Foreign Application Priority Data
Dec. 20, 2006 (DE) 10 2006 060 932.8

(51) Int. Cl. H01M 8/02; D06M 10/02; D06M 14/18; D06M 14/20; D06M 14/22; D06M 14/24; D06M 14/26; D06M 14/28; D06M 14/30; D06M 14/32; D06M 14/34; D06M 14/36; B01D 39/16

(52) U.S. Cl. 429/34; 427/569; 427/458; 427/538; 442/136; 442/146; 442/91; 442/79; 442/80; 428/220; 442/76

(57) ABSTRACT

The invention relates to fabrics, comprising fibers and a coating that is covalently bound on the surface of the fibers, characterized in that the fabrics are temperature-stable at 200° C. The invention further relates to methods for the production thereof, fuel cells and gas diffusion layers comprising the fabrics, and to the use thereof in fuel cells and gas diffusion layers.

### TECHNICAL FIELD

The present invention relates to temperature-stable planar fabric, comprising fibers and a coating that is covalently bound on the surface of the fibers, wherein the fabrics are temperature resistant at 200° C. Temperature-resistant fabrics are of interest for a plurality of technical applications, particularly as gas diffusion layers or components of a gas diffusion layer in fuel cells.

### STATE OF THE ART

A fuel cell is a galvanic cell that converts the chemical reaction energy of a continuously fed fuel and an oxidation agent into electric energy. Hydrogen-oxygen fuel cells are particularly important. Hydrogen is oxidized at the anode and oxygen is reduced at the cathode.

Fuel cells of said kind are composed of layers that are arranged in a certain way. The catalytic layers, on which the actual chemical reactions take place, are located on both sides of a membrane. Microporous layers (MLP) can follow the catalytic layers on the side facing away from the membranes, said layers usually being associated with gas diffusion layers (GLD). Although no electrochemical reactions take place on said layers, they play an important role for the function by feeding the reactants to the reaction sites and by removing the accumulated water from the electrodes.

According to the state of the art, gas diffusion layers often comprise carbon paper or nonwoven materials made of carbon fibers. Methods are known to increase the hydrophobicity of the gas diffusion layers and the microporous layers. Hereby, they are coated with fluoropolymers, as for example polytetrafluoroethylene. The coating can for example be carried out by impregnation.

Contrary to wet chemical methods like impregnation, a plasma coating provides a treatment by which the physical-chemical properties of the matrix, that is to say the bulk phase of a fabric, are not changed. Moreover, a plasma treatment is relatively inexpensive compared to a wet chemical treatment.

JP 2002025562 describes a method for coating gas diffusion layers made of carbon paper with fluorocarbon compounds. The coating is carried out by treating carbon paper in plasma. JP 2002025562 does not however disclose the surface treatment of nonwoven materials.

WO 2006/048649 and WO 2006/048650 disclose methods for plasma coating different surfaces. The coating of nonwoven materials is not disclosed.

Fuel cells operate at high temperatures. For PEM fuel cells, generally operating temperatures of 60 to 120° C. are the norm. Depending on the design of the fuel cell, however, operating temperatures of up to 200° C. are also reached. With other fuel cells, the temperatures are sometimes even considerably higher.

The plasma-coated nonwoven materials known from the state of the art, however, generally have low temperature resistance. As a result, the surface coating deteriorates over time and the properties conveyed by the coating, like oleophobicity or hydrophobicity, are lost.

### DESCRIPTION OF THE INVENTION

The object of the present invention is to provide coated nonwoven materials that are temperature-stable. In particular, the nonwoven materials are to be suitable for the use as gas diffusion layers in fuel cells. The nonwoven materials are also to be produced in a simple, energy-conserving and environmentally friendly way.

Surprisingly, the object of the invention is achieved by fabrics, methods for the production thereof, uses, gas diffusion layers and fuel cells according to the independent claims.

The object of the invention is particularly a fabric, comprising fibers and a coating that is covalently bound on the surface of the fibers, wherein the nonwoven material is heat-resistant at 200° C.

The fabrics, before carrying out the coating reaction according to the invention, are referred to as “starting materials” in the following. A nonwoven material, often called unbonded web, is a textile fabric comprising individual fibers. Contrary hereto, woven fabrics, knitted and interlaced fabrics are produced of yarns and membranes of films.

The coated fabrics and starting materials according to the invention are porous. This means that hollow spaces are present on the inside, which are connected to each other in such a way that, for example, a gas can get from one side of the fabric to the other side. Therefore, the fibers inside the starting material of the coating are also accessible with the coating in plasma.

According to the invention, starting materials that are porous are suitable for coating. However, all textile fabrics known from the state of the art, as for example nonwoven materials, knitted fabrics and woven fabrics can be used as starting materials.

In a preferred embodiment, the fabric according to the invention comprises no bonding agent. This is particularly cost-effective.

The coated fabrics according to the invention are temperature-stable at 200° C. referably, the fabrics are stable at temperatures of 150° C., 250° C., 300° C., 350° C. or 380° C.

“Stable” means that the structures of the coated fabrics are not or not substantially changed at these temperatures. Particularly, the coating should not separate or should substantially not separate from the fibers. In preferred embodiments less than 10%, 5% or 2% of the coating is separated from the fibers.

“Temperature stable” according to the invention means that the fabrics remain stable when exposed to the above-mentioned temperatures over a longer period of time. Preferably, the stability is to be provided for at least 1, 5, or 24 hours. In a particularly preferred embodiment, the stability is to be maintained even with a temperature treatment of more than 5 or 10 days, particularly preferred of more than 100 days. A coated fabric is particularly temperature-stable if it remains stable for at least one hour at 200° C.

For measuring the stability, different options are available. A coated fabric is temperature-stable, for example, if hydrophobicity or the oil repellant properties (oleophobicity) are maintained at increased temperature.

Oleophobicity can be determined, for example, according to the testing method 118-2002 of the AATCC. Other testing methods known according to the state of the art, however, can also be used.

In a preferred embodiment, temperature-stable means that the measured value according to the standard 118-2202 AATCC does not decrease by more than 2, particularly preferred by no more than 1, after temperature treatment.

For measuring the stability, changes of other material properties caused by the coated surface can be tracked.

Stability is generally present if properties caused by the coating do not change considerably as a result of the temperature. Determining the stability can also be carried out by means of analytical methods, like spectroscopic measurements or microscopic examinations, or can be supplemented by such methods.

In a further preferred embodiment, the fabrics according to the invention are oleophobic (oil repellant). This property can, for example, be determined in that the “oil value” (also referred to as “oil repellency”) according to the testing method 118-2002 of the AATCC (American Association of Textile Chemists and Colorists), called “Oil Repellency” or “Hydrocarbon Resistance” test, is determined. According to this testing method, droplets of standardized test liquids, comprising a defined series of hydrocarbons with different surface tensions, are added to the surface of the nonwoven materials and the wettability is examined. An “oil repellence degree” is obtained, corresponding to the highest numbered test liquid that does not wet the surface of the fabric. Preferably, the materials according to the invention in said testing method have a value of at least 2, particularly preferred at least 4 or at least 6.

In a further preferred embodiment, the fabrics according to the invention are hydrophobic. “Hydrophobic” in particular means that the fabrics are substantially not wettable with water. The hydrophobicity can be measured according to the sessile drop method with static or dynamic contact angle.

The fabrics according to the invention, however, can also be hydrophilic. This means in particular that the fabrics can be wetted well with water.

Starting materials made of carbon fibers are particularly suitable according to the invention. Preferably they are uncoated, but also may already comprise a coating. Different polymers can be used as thread-forming polymers, depending on the intended use. Examples of organic polymers are polyester, particularly polyethylene terephthalate, polybutylene terephthalate or copolymers comprising polyethylene terephthalate units or polybutylene terephthalate units, polyamides, particularly of aliphatic diamines and dicarboxylic acids, polyamides derived from aliphatic aminocarboxylic acids or aliphatic lactams, or aramids, that is polyamides derived from aromatic diamines and dicarboxylic acids, polyvinyl alcohol, viscose, cellulose, polyolefins, like polyethylene or polypropylene, polysulfones, like polyethersulfones or polyphenylene sulfone, polyarylene sulfides, like polyphenylene sulfide, polycarbonate, polyimides or polybenzimidazole or mixtures of two or more of said polymers.

The starting materials may also be coated, for example with hydrophobic polymers, particularly fluoropolymers like polytetrafluoroethylene (PTFE), or a mixture of conductive material and the hydrophobic polymers. Carbon black, graphite or metals can be used as conductive materials. The fluoropolymers can hereby be used as bonding agents for the conductive material. The fluoropolymers can also be used as bonding agents for fibers, for example of a nonwoven material, interlaced fabric or another textile fabric. The fluoropolymers are only indicated as exemplary bonding agents.

A coating according to this application refers to any partial or complete superficially or at least regionally penetrating covering of a fabric. It is particularly conceivable that the coating is created as a result of impregnation that has penetrated into the bulk phase or the matrix of the fabric to be coated. The coating can wet the whole matrix of the fabric and can completely penetrate it. It is also conceivable that the coating penetrates the matrix only partially. By painting or doctoring, a coating, for example an MLP (microporous layer), can be obtained. By painting or doctoring, a relatively thick coating can be obtained.

It is also conceivable that the described coating, particularly the impregnation, is only applied after the plasma treatment of an uncoated starting material. Due to the prior plasma treatment, the starting material is hydrophobized and too deep penetration of the coating into the interior of the starting material is prevented.

A combination of any coating, particularly however a coating by impregnation and plasma coating can lead to product properties that can not be obtained by means known from the state of the art. Very high temperature stability can be achieved with a plasma treatment of an already coated fabric, particularly of an already coated nonwoven material.

Gas diffusion layers can be used as starting materials. The gas diffusion layers can either be uncoated, coated with a microporous layer or can be hydrophobized and uncoated. It is also conceivable that the gas diffusion layers are hydrophobized and coated with a microporous layer.

The plasma coating preferably comprises fluorinated hydrocarbons. These are particularly fluorinated hydrocarbons with at least one C=C double bond. Particularly preferred are those comprising 8 to 15 carbon atoms, particularly 10 to 13 carbon atoms. Esters from fluorinated alcohols and methacrylic acid or acrylic acid are also suitable. The fluorinated hydrocarbons are particularly selected from the group consisting of heptadecafluorodecyl acrylate (HDFDA) and heptadecafluorodecene (HDFD) with the following formulas:

HDFDA heptadecafluorodecyl acrylate

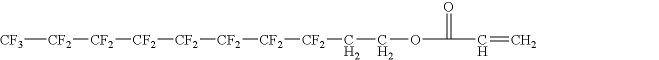

HDFD heptadecafluorodecene

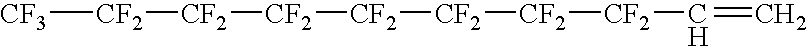

These compounds are covalently bound to the surface of the fabric. The fabric according to the invention is thus a reaction product of said compounds with the starting material.

The structure of the surface layer is chemically not exactly defined. It is a cross-linked addition product of the low molecular starting materials on the fibers activated in the plasma. “Low molecular” means that the starting substance is not polymeric before the reaction. “Polymeric” particularly relates to chemical compounds comprising more than 20, particularly more than 15 monomer units. The low molecular starting substance can be chemically altered after covalent linking with the fibers, for example by a carbon-carbon double bond being altered into a single bond and one of the two carbon atoms forming a covalent bond with the fiber. The stipulation that the coating comprises or contains a low molecular compound (like HDFD) thus corresponds in the present application to the stipulation that the low molecular compound was used for the production of the coating.

The starting materials required for the production of coated nonwoven materials can be produced using arbitary and already known methods, in wet, dry or other ways. Thus, spun-bonded methods, carding methods, melt-blowing methods, wet-laid methods, electrostatic spinning or aerodynamic nonwoven material production methods can be used. The functionalized nonwoven materials can thus be spun-bonded nonwoven materials, meltblown nonwoven materials, staple fiber nonwoven materials, wet-laid nonwoven materials or hybrid media of said nonwoven materials, like meltblown/wet-laid nonwoven materials or meltblown/staple fiber nonwoven materials.

The fabrics according to the invention can be made of arbitrary types of fibers with different diameter ranges. Typical diameters of the fibers are within the range of 0.01 to 200 μm, preferably 0.05 to 50 μm. In addition to endless fibers, said fabrics can also be made of staple fibers or can comprise them. In addition to monocomponent fibers, bicomponent fibers, filled fibers or mixtures of different types of fibers can be used. Typically, the functionalized fabrics have a basis weight of 0.05 to 500 g/m². Particularly preferred, functionalized fabrics with low basis weights of 1 to 150 g/m² are used.

The functionalized fabrics according to the invention can be bonded by methods, for example by mechanical or hydromechanical needling or by chemical or thermal bonding.

The functionalized fabrics according to the invention are preferably produced by a plasma treatment. Hereby, the fibers of the starting material are covalently bound to at least one low molecular compound. The coating is carried out on the surface of the fibers. As the fabrics are porous, the coating in the plasma is also carried out on the fibers within the fabric.

The stability of the resulting surface layer can be increased by certain measures. Compounds having a cross linking effect for the plasma can be added, or an activation of the fibers by plasma treatment without the addition of functionalizing substances is carried out, or a multiple functionalization is carried out, before the actual functionalization of the fabric, thus forming multilayers.

With the functionalization of the fibers according to the invention, only small amounts are deposited on the fiber surface. This is apparent in a low thickness of the layers formed on the fibers. The layers are preferably formed relatively even. It is however possible that the thickness of the coating is subject to local fluctuations and that also regions having a low layer thickness or without coating are obtained. Preferably, said regions are less than 10%, particularly less than 5% of the surface of the fabric. Regions of said kind may for example be present at the inside of the plasma-treated, functionalized fabrics. Preferably, all fibers of the functionalized fabrics according to the invention comprise surface layers.

In light of this, it is conceivable that the plasma treatment is only carried out on one side of the fabric, on both sides of the fabric or within the whole matrix of the fabric. A coating gradient could also be produced by the plasma treatment.

The thickness of the layers is less than 200 nm in a preferred embodiment, in preferred embodiments less than 100 nm or than 50 nm, particularly preferred between 5 and 100 nm. The diameter of the coating can be determined for example by x-ray photoelectron spectroscopy (XPS). With this method, layer thicknesses of up to 100 nm can be determined, which corresponds to the theoretical information depth of this surface analytical method. Larger layer thicknesses can be determined by means of AFM, ellipsometry or SEM.

The object of the invention also relates to the production of a coated fabric that is temperature-stable at 200° C., characterized in that a reaction is carried out in plasma with

a) at least one low molecular organic compound and

b) a starting material, in such a way that the coated temperature-stable fabric is obtained, wherein the low molecular compound is covalently bound to the starting material.

A coated fabric is obtained as a reaction product, in which the starting material is covalently bound to the organic compound. The surface of the fibers of the fabric is coated in the product. The fabrics described above can be obtained by this production method. The starting materials described above, particularly the fibers and the fluorinated hydrocarbons, can be used with said method.

The plasma is generally produced by applying an electrostatic field. The plasma treatment is carried out in a preferred embodiment by continuously guiding the starting material through the plasma discharge in a plasma chamber. Typical web speeds are 0.5 to 400 m/min. A high electrostatic field of several thousand kV preferably exists in the plasma chamber. The compound with which the fibers are coated is injected into said chamber. Under the effect of the plasma, the fabric and the compound are chemically activated and form covalent bonds. A fabric is obtained, that is coated with the fluorinated compound on the surface.

The plasma should be present over the whole volume of the fabric in a planar way in a preferred embodiment. In a preferred embodiment of the invention, the organic compound is a) injected into a plasma chamber in such a way that it is present in finely divided form and the starting material b) is transported through the plasma.

Plasma burning at atmospheric pressure is preferably used as plasma according to the invention, as described in WO-A-03/84,682 or WO-A-03/86,031. The device disclosed in WO-A-03/86,031 for producing atmospheric plasma for the coating of materials is also suitable. The fluorinated hydrocarbon is activated under the conditions of the plasma treatment, wherein the structure is substantially maintained. When coming in contact with the surface of the fiber, a covalent bond is obtained.

In a particularly preferred embodiment of the invention, a method for producing plasma is used, as described in WO 2006/048649 and WO 2006/048650. Reference is hereby expressly made to said methods, particularly to the associated claims, the associated paragraphs [0056] and examples 1 of WO 2006/048649 and WO 2006/048650.

According to the method of those two publications, under atmospheric pressure plasma is produced that is not in equilibrium. A device is used, wherein at least one electrode is positioned in a dielectric container, comprising one inlet and one outlet opening. Preferably, a radiofrequency high voltage is applied to at least one of the two electrodes.

According to the methods described in this application, a mixture of reaction gas and monomer is injected under pressure into a container. Plasma is produced. This flame-like cold plasma is directed at the starting material, which is guided underneath the nozzle. A monomer polymerizes from the mixture on the surface of the starting material.

The substantial difference of the method, with which example 4 was produced, compared to the methods, with which examples 1 to 3 are produced is that in example 4, the starting material is not guided through the plasma zone. Thus, the starting material can not be damaged. The advantage of this method is that the plasma may have higher energy.

The plasma treatment according to the invention is carried out in an oxidizing or preferably non-oxidizing atmosphere with, for example, a noble gas as inert gas, like helium or argon. The addition of further reactive gases or additives in the plasma can be omitted.

Preferably, the working pressure in the plasma is between 0.7 to 1.3 bar, preferably between 0.9 to 1.1 bar. Carrying out the treatment at atmospheric pressure is particularly preferred.

In a preferred embodiment of the invention, a cross-linking agent with at least two reactive groups, preferably ethylenically unsaturated groups, particularly preferred with at least two vinyl groups, is added to the plasma.

Further preferred versions of the methods described above comprise a separate activation of the starting material before the actual reaction with the compound by plasma treatment in inert gas atmosphere or with air.

According to the invention, several plasma treatments are also possible, forming multiple layers. The fabrics according to the invention can be produced in the plasma without solvents.

The fabrics of the invention are excellently suited as gas diffusion layers (GDL) or as components of gas diffusion layers in fuel cells. They only comprise small amounts of functionalizing material and can be produced in a simple, energy-saving and environmentally friendly way. Furthermore, the fabrics have excellent properties, particularly in respect to the gas transport. Furthermore, the fabrics have very good electrical properties, that is to say, good electric conductivity. This is due to the fact that the plasma treatment hardly affects the electric properties of the fabric.

The fabric according to the invention can in particular be used as a gas diffusion layer in PEM (polymer electrolyte membrane) fuel cells. Use in DMFC (direct methanol fuel cells) fuel cells is also conceivable. Furthermore, use as a gas diffusion electrode in electrolysis cells is conceivable.

The invention also relates to a gas diffusion layer, comprising or being made of a fabric according to the invention.

A further object of the invention is a fuel cell, comprising a fabric according to the invention or a gas diffusion layer according to the invention.

The use of the fabric according to the invention in fuel cells is also an object of the invention. The fabrics can be used as a gas diffusion layer or as a component of a gas diffusion layer. A particularly preferred use according to the invention is the use of the fabrics as gas diffusion layers, for example in fuel cells, at increased temperatures like 150° C., 200° C., 250° C., 300° C., 350° C., or 380° C. This corresponds to the operating temperature of different fuel cells.

When carrying out the coating method according to the invention, the starting material can be pretreated and/or can be bonded to further layers. During production of the fabrics according to the invention for fuel cells, the starting material can be bonded to a microporous layer (MLP) before the plasma coating. Microporous layers of said kind are known and usually comprise finely divided carbon (particularly carbon black), that is hardened with a hydrophobic binding agent.

In a further embodiment of the invention, the starting material is first impregnated with a coating of PTFE (polytetrafluoroethylene), optionally in conjunction with carbon black, according to known methods, before the coating according to the invention is carried out. In this way, the fiber surface is first hydrophobized. Then the coating in the plasma according to the invention is carried out.

An object of the invention is also a gas diffusion layer, comprising the temperature-stable coated fabrics according to the invention that is bonded to a microporous layer. Other arrangements and variations of the layers can also be carried out, which can be used in a fuel cell and a gas diffusion layer.

It should be specifically pointed out that the fabrics mentioned in this application can be configured as nonwoven materials, woven fabrics, knitted fabrics or textiles.

Specifically, it is conceivable that the fabrics described herein can comprise a conductive nonwoven material as starting material, as described in EP 1 328 947 A. The content of EP 1 328 947 A is expressly included in the disclosure of this application.

A conductive nonwoven material is dissolved there, which is carbonized and/or graphitized, having a density of 0.1 g/cm³ to 0.5 g/cm³, a thickness of 80 μm to 500 μm and electric conductivity of 10 to 300 S/cm in the nonwoven material web and 30 to 220 S/cm² perpendicular to the nonwoven material web.

Said nonwoven material can be bent and rolled without damage and is thus particularly suitable for use in fuel cells.

Said conductive nonwoven material is obtained from preoxidized fibers as precursors for carbon fibers, which are optionally mixed with a precursor fiber as binding fiber up to 30 wt.-% and with a water-soluble fiber with fiber titers of 0.5 to 6.7 dtex up to 30 wt.-%, laid to form a fibrous web having a basis weight of 60 to 300 g/m², bonded by means of high-pressure fluid jet treatment at pressures of 100 to 300 bar of the fibrous web, compacted by calendaring the bonded fibrous web by 50 to 90% of the initial thickness thereof, and carbonized and/or graphitized under a protective atmosphere at 800° C. to 2500° C.

The resulting conductive nonwoven material comprises a channel structure in the direction of the layer thickness of the nonwoven material. The preoxidized fibers and optionally the binding and water-soluble fibers are mixed in a homogenous way and are laid to form a fibrous web. The fibrous web having basis weights of 30 to 300 g/m² is fed to a reinforcement unit, wherein the fibers are twisted and knotted by means of highly energetic water beams under pressures of 100 to 300 bars. A part of the fibers has an orientation towards the Z-direction (thickness) of the nonwoven material after said treatment.

Preferably, the conductive nonwoven material fiber is used with 80 to 90 wt.-% of a mixture of binding fibers and preoxidized fibers in a weight ratio of 0:1 to 1:3 and 10 to 20 wt.-% of a water-soluble fiber with fiber titers of 0.8 to 3.3 dtex. Said composition of the fibers and the finenesses thereof result in conductive nonwoven materials with porosities of 70 to 95. Preferably the conductive nonwoven material is one in which two different water-soluble fibers are used. One thereof is water-soluble at temperatures of 10 to 40° C. and the other one at temperatures of 80 to 120° C. By using different water-soluble fibers, the fibers are already extracted in a temperature range of 10 to 40° C. during the water jet reinforcement of the fibrous web and defined channels are formed in the nonwoven material layer, allowing for improved gas permeability and improved removal of the resulting reaction water in the gas diffusion layer produced thereof. The fibers that are only water-soluble in a temperature range of 80 to 120° C. remain in the bonded nonwoven material and are turned into binding fibers in the wet state due to the adhesiveness thereof. The nonwoven material is therefore led through a calendar and is bonded in the wet state.

The conductive nonwoven material is preferably one with a ratio of the water-soluble fibers to each other of 3:1 to 1:3. Due to this ratio, the rigidity of the gas diffusion layer and the porosity thereof can be adjusted.

Particularly preferred is a conductive nonwoven material, comprising a plurality of fiber layers with different pore sizes, wherein the fibers of the individual layers have different titers. The progressive design of the conductive nonwoven material of a plurality of fiber layers favors the transport reaction to the proton exchange membrane and the removal of the generated reaction water.

Particularly preferred are conductive nonwoven materials, in which partially cross-linked phenolic resin fibers, polyester and/or polypropylene fibers are used as precursor fibers, homo, co and/or terpolymers of PAN (polyacrylnitrile) fibers, cellulose fibers and/or phenolic resin fibers are used as preoxidized fibers, and PVA (polyvinyl alcohol)fibers are used as water-soluble fibers.

The gas diffusion fiber layer obtained from a nonwoven material of said fibers can be carbonized well and can be easily adjusted regarding the pore distribution and the rigidity thereof.

Particularly preferred is a conductive nonwoven material that is hydrophobized by applying a hydrophobing agent like PTFE (polytetrafluoroethylene). Due to hydrophobizing, the transport processes on the interphase regions can be further improved.

The conductive nonwoven material is produced in such a way, that

a) preoxidized fibers, optional in a mixture with up to 30 wt.% of carbonizable precursor fibers as binding fibers and up to 30 wt.% of water-soluble fibers are mixed,

b) are laid to form a fibrous web with a basis weight of 60 to 300 g/m² by dry means using teasting and/or carding machines.

c) are bonded by high-pressure fluid jet treatment at pressures from 100 to 300 bar,

d) are pre-dried up to a residual moisture from 10 to 50%

e) are calendared at contact pressures from 20 to 1000 N/Cm² and temperatures of 100 to 400° C.

f) are carbonized and/or graphitized at temperatures between 800 and 2500° C.

Preferably the production is carried out in that in the step

a) fibers with a fiber titer of 0.8 to 3.3 dtex and a fiber length of 30 to 70 mm are used,

b) fibrous webs with a basis weight from 30 to 180 g/m² are laid and

e) calendarized at contact pressures from 40 to 700 N/Cm² and temperatures from 180 to 300° C. and

f) carbonized and graphitized at temperatures between 1000 and 1800° C.

Particularly preferred is that in the step

e) at least two nonwoven material layers are calendared together.

The conductive nonwoven material could be used with a density from 0.1 g/cm³ to 0.25 g/cm³ as a base material for electrodes and gas diffusion layers.

The conductive nonwoven material could be used with a density of 0.25 g/cm³ to 0.40 g/cm³ as gas diffusion layers in polymer electrolyte fuel cells.

The conductive nonwoven material could be used with a density of 0.40 g/cm³ to 0.50 g/cm³ as an electrode in supercapacitors.

### SHORT DESCRIPTION OF THE DRAWINGS

The drawings show in

FIG. 1 a scanning electron microscope (SEM) image of the non-treated starting nonwoven material according to example 1 and in

FIG. 2 a scanning electron microscope (SEM) image of the plasma-coated nonwoven material according to example 1.

### EMBODIMENT OF THE INVENTION

### Example 1

A nonwoven material comprising mainly carbon fibers was functionalized in atmospheric pressure plasma in a device, as described in WO 06086031 and WO 04068916.

Helium was used as inert gas. A 1:1 (volume/volume) mixture of heptadecafluorodecylacrylate (HDFDA) and heptadecafluorodecene (HDFD) was used as reactive substance. The plasma treatment was carried out without oxygen.

### Example 2

A nonwoven material comprising mainly carbon fibers was functionalized in atmospheric pressure plasma in a device, as described in WO 06086031 and WO 04068916.

The samples were activated in plasma in a helium-oxygen mixture. Then the fuctionalization was carried out, wherein helium was used as inert gas. A 1:1 (volume/volume) mixture of heptadecafluorodecylacrylate (HDFDA) and heptadecafluorodecene (HDFD) was used as reactive substance. The plasma treatment was carried out without oxygen.

### Example 3

A nonwoven material comprising mainly carbon fibers was functionalized in atmospheric pressure plasma in a device, as described in WO 06086031 and WO 04068916.

The samples were activated in plasma in a helium-oxygen mixture. Then the fuctionalization was carried out, wherein helium was used as inert gas. Heptadecafluorodecene (HDFD) was used as reactive substance. The plasma treatment was carried out without oxygen.

### Example 4

A nonwoven material comprising mainly carbon fibers was functionalized in atmospheric pressure plasma in a device, as described in WO 06068650 and WO 06048649.

Helium was used as inert gas. Heptadecafluorodecylacrylate (HDFDA) was used as reactive substance. The plasma treatment was carried out without oxygen.

Characterization of the nonwoven materials:

Oleophobicity was determined according to testing method AATCC 118-2002. The results are shown in table 1.

Determining the temperature stability:

The coated nonwoven materials obtained according to examples 1 to 4 were exposed to high temperatures in air for predetermined time frames. The oil repellence was then determined according to the testing method AATCC 118-2002. The results are shown in table 1. The coated nonwoven materials produced according to the invention show high temperature stability at 200° C.

TABLE 1
Thermal stability of the nonwoven materials when stored in air
at increased temperatures.

| | | | 1 h | | 100 h | 200 h | |
|---|---|---|---|---|---|---|---|
| | | | at | 50 h at | at | at | 1 h at |
| | Activation | Initial Oil value | 200° C. | 200° C. | 200° C. | 200° C. | 380° C. |
| Example 1 | no | 6 | 5 | 1 | — | — | 0 |
| Example 2 | yes | 4 | 3 | 2 | — | — | 1 |
| Example 3 | yes | 2 | 1 | 0 | — | — | 0 |
| Example 4 | | 7 | 8 | 8 | 7 | 6 | 0 |

The number values each indicate the oil repellence.
(—) denotes “not determined”.

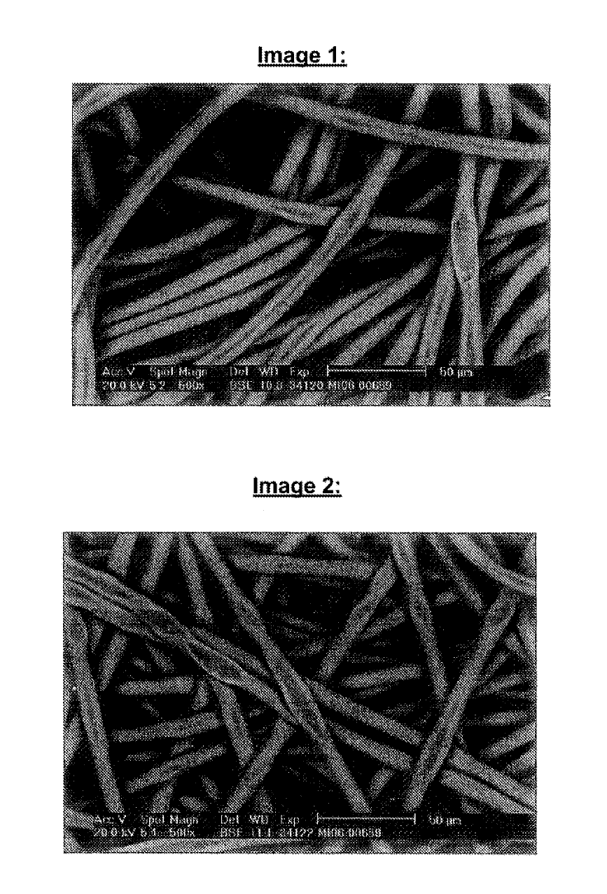

The coated nonwoven materials from example 1 were furthermore examined by scanning electron microscopy (SEM) and compared to the non-coated starting nonwoven materials. The result is shown in FIGS. 1 and 2.

No difference in the structures with or without coating is apparent from the SEM images. This shows that the coatings according to the invention are very thin. In classic wet chemical coating methods, a difference is clearly visible in corresponding images due to the thickness of the coatings.

The element composition of coated and uncoated nonwoven materials from example 1 was determined by way of XPS spectroscopy. The result is shown in table 2.

TABLE 2
Element composition of the surfaces of the nonwoven
materials, measured by way of XPS-spectroscopy.

| | C | O | F | N |
|---|---|---|---|---|
| Untreated | 95 | 4 | 1 | 1 |
| According to | 58 | 9 | 31 | 2 |
| example 1 | | | | |

The relative concentration of the atoms in indicated in atom-%.

What is claimed is:

1. A fabric, comprising fibers and a coating, that is covalently bound on the surface of the fibers, wherein the fabric is temperature-resistant at 200° C.

2. The fabric according to claim 1, wherein the fibers are selected from the group consisting of carbon fibers, polyamide fibers, polyester fibers, aramide fibers, polyvinyl alcohol fibers, viscose fibers, cellulose fibers, polyolefin fibers, particularly polyethylene fibers or polypropylene fibers, polysulfone fibers, particularly polyethersulfone fibers or polyphenylene sulfone fibers, polyarylene sulfide fibers, particularly polyphenylene sulfide fibers, polycarbonate fibers, polyimide fibers, polybenzimidazole fibers or mixtures of two or more thereof.

3. The fabric according to claim 1, characterized by a configuration as a nonwoven material from the group consisting of spun-bonded nonwoven material, meltblown nonwoven material, staple fiber nonwoven material, wet-laid nonwoven or hybrid media of said nonwoven materials.

4. The fabric according to claim 1, wherein the coating comprises fluorinated unsaturated or cyclic organic monomers.

5. The fabric according to claim 4, the fluorinated monomers are selected from the group consisting of heptadecafluorodecyl acrylate and heptadecafluorodecene.

6. A The fabric according to claim 1, wherein the coating is hydrophobic and/or oleophobic.

7. The fabric according to claim 1, characterized by electric conductivity.

8. A The fabric according to claim 1, wherein the coating has a thickness of <200 nm.

9. A The fabric according to claim 1, characterized by a configuration as a gas diffusion layer for a fuel cell.

10. The fabric according to claim 1, wherein the coating is applied to the fibers by plasma coating.

11. A The fabric according to claim 1, characterized by a configuration as a conductive nonwoven material that is carbonized and/or graphitized, has a density of 0.1 g/cm³ to 0.5 g/cm³, a thickness of 80 μm to 500 μm and electric conductivity of 10 to 300 S/cm² in the nonwoven material web and 30 to 220 S/cm² perpendicular to the nonwoven material web.

12. A gas diffusion layer, comprising a fabric according to claim 1.

13. A fuel cell, comprising a fabric or gas diffusion layer according to claim 1.

14. A method for the production of a coated fabric that is temperature-stable at 200° C., characterized in that a reaction is carried out in a plasma of
a) at least one low molecular organic compound and
b) a starting material,
in such a way that the coated temperature-stable fabric is obtained, wherein the low molecular compound is covalently bound to the starting material.

15. The method according to claim 14, wherein the starting material is made of the fibers or comprises fibers that are selected from the group consisting of carbon fibers, polyamide fibers, polyester fibers, aramide fibers, polyvinyl alcohol fibers, viscose fibers, cellulose fibers, polyolefin fibers, particularly polyethylene fibers or polypropylene fibers, polysulfone fibers, particularly polyether sulfone fibers or polyphenylene sulfone fibers, polyarylene sulfide fibers, particularly polyphenylene sulfide fibers, polycarbonate fibers, polyimide fibers, polybenzimidazole fibers or mixtures of two or more thereof.

16. The method according to claim 14, wherein the low molecular organic compound comprises fluorinated unsaturated or cyclic organic monomers.

17. The method according to claim 16, wherein the fluorinated monomers are selected from the group consisting of heptadecafluorodecyl acrylate and heptadecafluorodecene.

18. A The method for the production of a coated fabric according to claim 14, wherein the organic compound is a) sprayed into a plasma chamber in such a way that it is present in a finely divided manner and the starting material b) is transported through the plasma.

19. A The method for the production of a coated fabric according to claim 14, wherein the plasma is created by applying an electrostatic field.

20. The method for the production of a coated fabric according to claim 14, wherein the reaction is carried out at pressures between 0.7 and 1.3 bar and in a non-oxidizing atmosphere.

21. The method for the production of a coated fabric according to claim 14, wherein the reaction is carried out at atmospheric pressure.

22. The method for the production of a coated fabric according to claim 14, wherein cross-linking agents with at least two reactive groups, preferably ethylenically unsaturated groups, particularly preferred at least two vinyl groups, are added to the plasma.

23. The method for the production of a coated nonwoven material according to claim 14, wherein the starting material a) is activated by plasma treatment in inert gas atmosphere or with air before carrying out the reaction.

24. A nonwoven material that can be obtained according to the method of claim 14.

25. Use of a fabric according to claim 14 as a gas diffusion layer or as a component of a gas diffusion layer.

26. Use of a fabric according to claim 1 or a gas diffusion layer in fuel cells.

27. The use according to claim 25 or at a temperature of 200° C.
